(19) United States
(12) Patent Application Publication
(10) Pub. No.: US 2006/0264214 A1
(43) Pub. Date: Nov. 23, 2006

(54) MODE-SWITCHING WIRELESS COMMUNICATIONS EQUIPMENT

(75) Inventors: Kenneth L. Stanwood, San Diego, CA (US); Yair Bourlas, San Diego, CA (US); Michael R. Donahoo, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: NEXTWAVE BROADBAND, INC., San Diego, CA (US)

(21) Appl. No.: 11/419,188

(22) Filed: May 18, 2006

Related U.S. Application Data
(60) Provisional application No. 60/683,500, filed on May 20, 2005.

(51) Int. Cl. H04Q 7/20

(52) U.S. Cl. 455/433

(57) ABSTRACT

A communication device with the ability to switch from operating as a base station to operating as a subscriber station or from a subscriber station to a base station. This enables point-to-multipoint systems with strong quality of service (Qos) to be developed with features, such as self-healing and self organization, normally only found in mesh systems with weak QoS.

### CROSS-REFERENCE TO RELATED APPLICATION

This application claims priority to Provisional Application No. 60/683,500, filed May 20, 2005, which is hereby incorporated by reference.

### BACKGROUND

1. Field of the Invention

This invention relates generally to wireless communications systems and more particularly to such a system particularly adapted for self-healing and self-organization.

2. Related Art

Point-to-multipoint (PmP) wireless network systems typically have a central access point, alternatively called a base station. This base station provides the connectivity to the outside world for the system. Client devices, alternatively called subscriber stations or customer premise equipment (CPE), communicate with other entities within the PmP network and outside of that network via the base station. Even communications between two entities within the same PmP network are accomplished via the access point rather than directly. A bridging or routing function usually resides in or just beyond the base station functionality which allows the data to be routed back to the CPE in the same network.

PmP systems can have centralized scheduling that can allow schedulers to provide very strong quality of service (QoS) as well as providing very efficient allocation of bandwidth. The strong QoS and centralized scheduling allows these networks to provide guaranteed low latency. Such networks are particularly effective when subscriber station desire to communicate with other devices not currently in the network defined by their current base station. Due to the high degree of asymmetry between a base station and a subscriber station in PmP systems with strong QoS, devices are typically designed, built, and statically configured to be one or the other. IEEE 802.16 and WiMAX systems are good examples of PmP wireless systems enabling strong QoS. These systems can be contrasted with IEEE 802.11 systems which are not centrally scheduled and do not provide deterministic QoS or delays.

Centrally scheduled PmP systems with strong QoS have the disadvantage that the base station is a single point of failure. If the base station malfunctions the entire wireless network is shut down. If an individual client subscriber station cannot communicate with the base station and an alternate base station is not within range, that client has no alternatives and all communication is lost. Additionally, PmP systems with strong QoS must be planned with a particular device acting as the base station and all communications going through that device.

Another existing type of wireless system is the mesh network. Mesh network systems take advantage of a subscriber station that can forward data to other similar subscriber stations. Mesh systems may have some number of subscriber stations that have direct access outside the mesh network. These subscriber station access points (AP), enable the mesh network subscriber station to communicate with the outside world. Mesh network systems can provide the benefit that clients may communicate directly with each other. Additionally, mesh networks can be “self-organizing”, which means they can establish connections between members of the network as required and as available to efficiently route data to the outside world. The highest degree of self-organization allows the networks to be “self-healing” where links are dynamically established and traffic re-routed if a path between two points degrades in some manner (for example, signal degradation, capacity problems, client device malfunction, etc.). Mesh networks are particularly effective when most of the traffic is between members of the mesh rather than with entities outside the mesh or in situations where the subscriber station population is too sparse to justify the quantity of base stations necessary to serve the user base in a PmP fashion.

Mesh systems have the disadvantage that QoS and latency cannot be deterministically guaranteed. As data moves through the network, especially towards an AP, it aggregates into increasingly greater bandwidth demand. This can cause congestion resulting in the loss or delay of data, adversely impacting QoS. Subscriber stations in mesh networks do not usually control or know the capacity of links beyond their neighboring client devices. So, they cannot guarantee QoS beyond their immediate links. Even on their immediate links, they may not be able to guarantee QoS due to traffic requested to be forwarded by other clients. Subscriber station cannot control the number of links that data traverses in a mesh network, so mesh networks cannot guarantee low or deterministic delays.

### SUMMARY

The systems and methods of the embodiments of current invention can provide the deterministic QoS and delay advantages of a PmP system with strong QoS while simultaneously providing the self-organizing and self-healing capabilities of a mesh network. The systems and methods can include a communication device that can be configured to provide functionality of either a base station or a subscriber station. In one embodiment that capability is contained on a single application specific integrated circuit ASIC or chip. The configurability of this system is not static like that of a typical PmP wireless network system. A device in the present system can change from operating as a subscriber station to operating as a base station and back again. Preferably, the change occurs with no, or very little, loss of data or down time.

One embodiment of such a communications system can be used in an IEEE 802.16e compliant system. 802.16e provides advanced antennae systems supporting beam forming and multiple input and multiple output (MIMO) which supports spatial diversity schemes, spatial multiplexing, and a combination of these two techniques. Furthermore, 802.16e supports multiple antennae and RF architectures. This can be used to provide an increase in the system capacity. The use of 802.16e further supports beam forming which enables the system to gain maximum coverage and availability, used for extended range or increased capacity, to penetrate walls, null interferences, reduce overall levels of interference, enable the subscriber station's to be omni/directional, and modify frame structure for network entry into the system. The system is available for use in mobile applications, in-home multimedia distribution, government/homeland defense applications, and fixed broadband access.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a high level flow diagram illustrating an example of the process used by a wireless self-healing system.

FIG. 2A is a representation of wireless network system with a base station and four subscriber stations.

FIG. 2B is a representation of wireless network system where the base station has been lost and one of the four subscriber stations has taken over.

FIG. 3 is a functional block diagram illustrating the hardware elements of an ASIC which can function either as subscriber station or base station.

FIG. 4 is a block diagram illustrating the functional modules of a network controller.

FIG. 5 is a diagram of a wireless network system running a multimedia distribution network for a home.

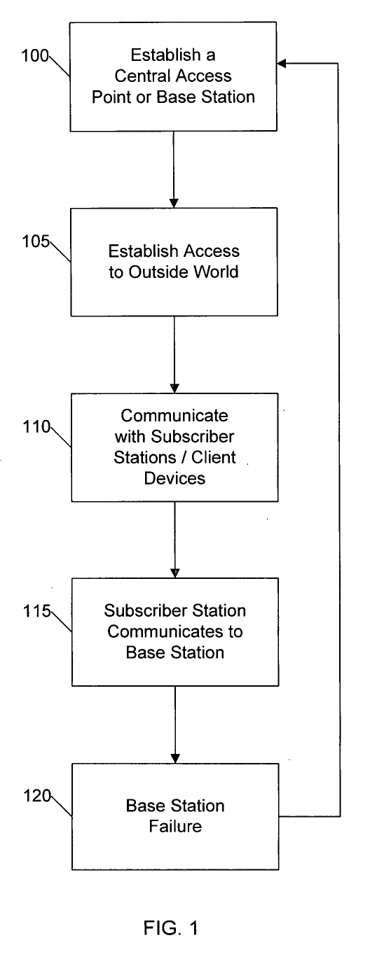

### DETAILED DESCRIPTION

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Embodiments described here include a method and a system which provides a wireless network which is both self-organizing and self-healing wherein a single communication device such as an ASIC can provide the functionality of either a base station or a subscriber station. This device can be defined as a switchable communication device. The system facilitates two-way communications between a plurality of subscriber station and a base station which communicates with an outside network. The system is dynamic and is not static like that of a typical point-to-multipoint wireless network system.

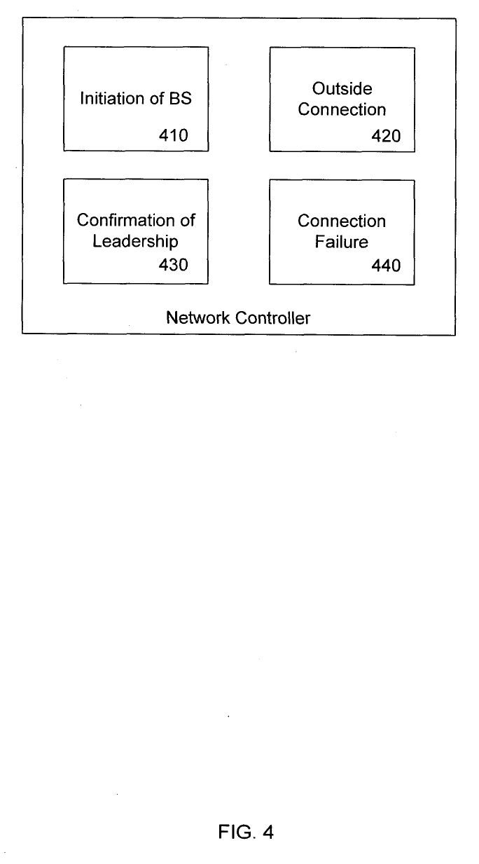

This system can be used in multiple situations. In a few different embodiments this system can be used as an in-home multimedia distribution network, in mobile applications, in government/homeland defense applications, and/or for fixed broadband access (BA). In every system there are one or more base stations and one or more subscriber stations. The base station communicates with the outside network and the subscriber stations communicate directly with the base station. Some or all of the subscriber stations have the capability to communicate with the outside network, however they do not utilize this capability unless they take over for the base station. If a base station of the system fails or cannot be located, an existing subscriber station of the system can take over its functionality so that there is no down time in the system communications. In one embodiment a base station could also switch to become a subscriber station. There are alternative methods in which a subscriber station can take over for a base station. These will be explained in more detail in connection with FIG. 4.

Figure (“FIG.”) 1 is a high level flow diagram illustrating an example of the process used by a wireless self-healing system. At step 100 the process establishes a central access point or base station. At step 105, the base station establishes access to an outside network. This access can be established to the world wide Internet network or other outside networks. In one embodiment the base station initializes outside network connection via a satellite communication link or other wireless and/or wired links. At step 110 the base station establishes communication with the subscriber stations. In one embodiment this can be accomplished by the base station sending a “downlink” transmission and waiting to receive “uplink” transmissions from the subscriber station(s). At step 115, once a subscriber station receives a “downlink” transmission from the base station it sends an “uplink” transmission back to the base station to register. This system is dynamic, thus a subscriber station can register with the base station at any time, not just at power on. In one embodiment the subscriber stations periodically send transmissions to the base station and wait for a response to confirm that the base station is still functioning. At step 120 the base station has failed. At step 100 a new base station is established by one of the existing subscriber station taking over the base station's functionalities.

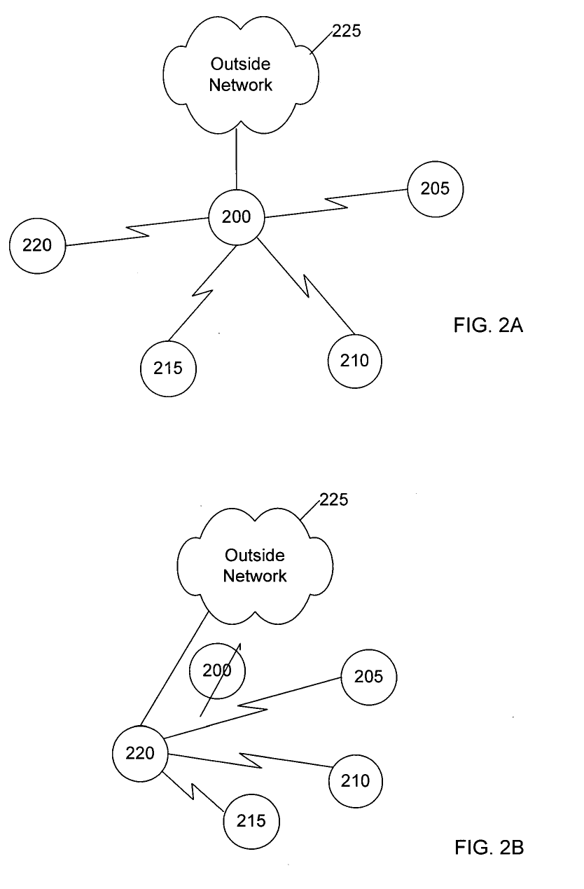

FIG. 2A is a representation of a wireless network system with a base station and four subscriber stations. The base station 200 communicates with the outside network 225. The base station 200 also communicates with four subscriber stations 220, 215, 210 and 205. In FIG. 2B the BS 200 has been removed from the system (such as due to destruction, malfunction, loss of power, physical movement, lack of capacity and the like.) The subscriber station 220 has taken over the functionality of the previous base station 200. Subscriber station 220 establishes a connection to the outside network 225 and further establishes connections to the existing subscriber stations 215, 210 and 205.

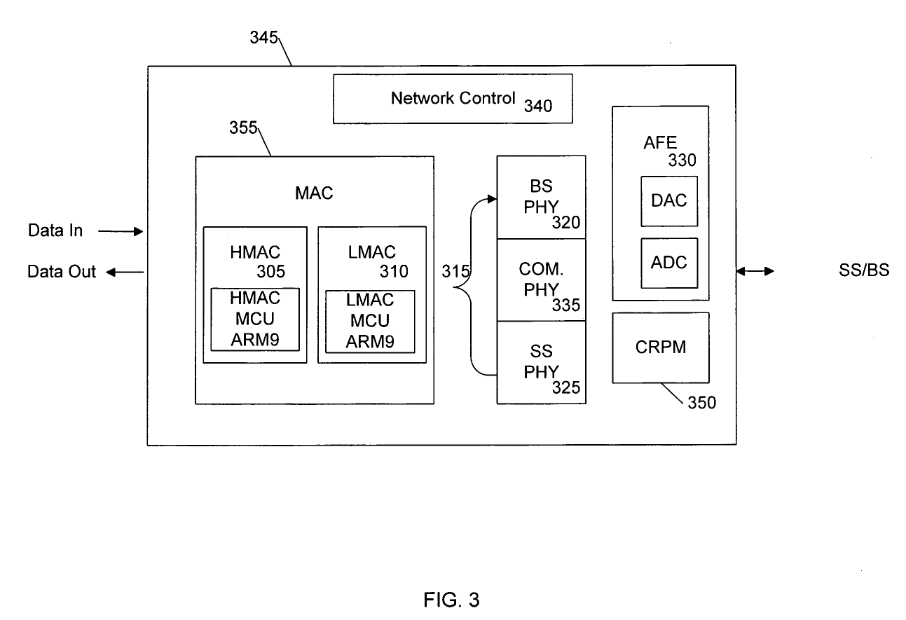

FIG. 3 is a functional block diagram illustrating the functional elements of a switchable communications device 345 which can function as either a subscriber station or base station. The high level media access control HMAC 305 and low level media access control LMAC 310 are a logical partitioning of the media access control (MAC) 355 functional entities into high and low sections and is for illustrative purposes only. Implementations may use other partitioning, including no partitioning of MAC functional entities. The MAC allocates available bandwidth on one or more physical channels on the uplink and the downlink. When requests for bandwidth arrive from the subscriber station the MAC software allocates the available bandwidth between the various services. The signaling protocol and the physical layer (PHY) 315 of each switchable communications device are asymmetrical between the base station PHY 320 and a subscriber station PHY 325. The physical elements which are used in both the base station and subscriber station, common elements (COM PHY) 335, are also resident in both.

The analog front end (AFE) 330 which provides the radio transmission capabilities, on the other hand, is largely symmetrical, meaning it can operate both in base station and access point mode. In some embodiments, it may be advantageous to equip a device capable of acting as a base station with more sophisticated antenna system capabilities. In one embodiment the parts of the MAC that are asymmetrical (e.g. incapable of operating in either base station or access point mode) are provided in software and the parts that are symmetrical (e.g. capable of operating in either base station or access point mode) are provided in hardware. Elements of the hardware that differ between the subscriber station and the base station, such as FFT and IFFT for implementation of subchannelization in OFDM and OFDMA systems and key handling mechanisms for encryption/decryption, are duplicated so that the ASIC has the necessary resources to support both modes. If an element is resident in a base station or subscriber station and is not needed in one mode of operation, it is bypassed in that mode. In one embodiment the LMAC 310 and the HMAC 305 can be switched to either base station or subscriber station with a minimum duplication of resources by loading software designed to implement one mode or the other on the same hardware.

In one embodiment the switchable communications device shown in FIG. 3 is configured to operate in orthogonal frequency division multiple access (OFDMA) WiMAX. In this embodiment the differences in operation between the subscriber station and base station modes are:

1) subscriber station processes received frame maps.

2) subscriber station maintains time and frequency synchronization with the base station.

3) subscriber station ranges and determines transmit time advance.

4) base station detects subscriber station time and frequency errors and commands subscriber station to adjust.

5) base station handles different subscriber station's with different power levels, on different sub-channels.

6) base station transmits using different PHY parameters (e.g., FEC and modulation) at different times in the same frame.

7) base station transmits using different PHY parameters on different sub-channels simultaneously.

8) base station receives using different PHY parameters on different sub-channels simultaneously.

9) subscriber station and base station both do various PHY functions, but the base station may do multiple instances in parallel, for example, FFT, IFFT, FEC, modulation, demodulation—all the basic PHY blocks.

In addition, a further higher level of control implemented in software or hardware runs above the MAC layer in the switchable communications device depicted in FIG. 3. This module is referred to as the network control module 340. This module is responsible for determining whether the switchable communications device functions as a base station or subscriber station. Alternatively, this function can be implemented off the switchable communications device. When a PmP network is originally configured, at least one device must operate as the base station for the network. If that base station is lost, the network control modules 340 of the remaining subscriber station must determine or be told which of them will become the new base station. Only subscriber stations that have connectivity outside of the network are qualified to become the base station.

FIG. 4 is a block diagram illustrating the functional modules of a network controller. The functional modules of a network controller include the initiation module 410, the outside connection module 420, the confirmation of leadership module 430 and the connection failure module 440.

The initiation module 410 first determines whether the switchable communications device will be a base station or a subscriber station. In one embodiment, this determination is based on the ability of the switchable communications device to connect to the outside network, its available bandwidth and its proximity to the other switchable communications devices. If a switchable communications device is determined to be a base station it establishes dedicated access to the outside network.

The outside connection module 420 is resident in all base stations and some subscriber stations. In a base station the outside connection module 420 establishes and maintains a dedicated connection to the outside network. In a subscriber station this module maintains the connection to the outside network by periodically sending transmissions, however it does not establish a dedicated connection unless it turns into a base station. If it is determined that a subscriber station is to be converted to a base station, module 420 will establish a dedicated connection to the outside network.

The confirmation of leadership module 430 functions both to register a subscriber station with the base station and also to confirm that a base station is still in contact. When a subscriber station first enters the system the confirmation of leadership module 430 sends out an “uplink” transmission to the base station in an attempt to register with the BS. The subscriber station waits for the base station to send it back a downlink transmission with registration information. The subscriber station then registers with the base station. Once a subscriber station has registered with the base station the confirmation of leadership module 430 sends periodic “uplink” transmissions to confirm that the base station is still in contact. Alternatively, this function can be implemented in the MAC.

The connection failure module 440 functions to establish a new base station if the subscriber stations fail to receive a confirmation that the base station is still functioning. This module notifies the initiation module 410 to establish a new base station. There are various ways that a system can pick a subscriber station to be the next base station. In one embodiment, the subscriber stations can negotiate with one another using predetermined variable criteria to ascertain which one will become the new base station after the current base station has failed. Factors that can be considered for such a negotiation would be bandwidth to and out of the network connection, and signal quality with the other base stations. In another embodiment a subscriber station is selected to be the next base station via a “next in line” plan which is implemented prior to the initial base station failing. A base station implements this “next in line” plan when it is launched wherein it selects the next in line based on various factors. In one embodiment these factors can be signal strength. These factors and/or the next in line choice can be changed over time. In this embodiment the subscriber station is provided with this information when it registered with the base station.

In a further embodiment a subscriber station takes over the functions of the failed base station by having each of the subscriber stations delay for a random period of time before sending out a signal announcing its presence as the new base station, after the current base station fails. Before transmitting that announcement the possible new base station listens to make sure it does not hear such a signal from another subscriber station. The random delay implemented in these “uplink” transmissions avoids collisions between signals and race conditions. In another embodiment a person can manually chose the next base station. Thus, if a base station fails human intervention is used to decide which subscriber station will become the new base station.

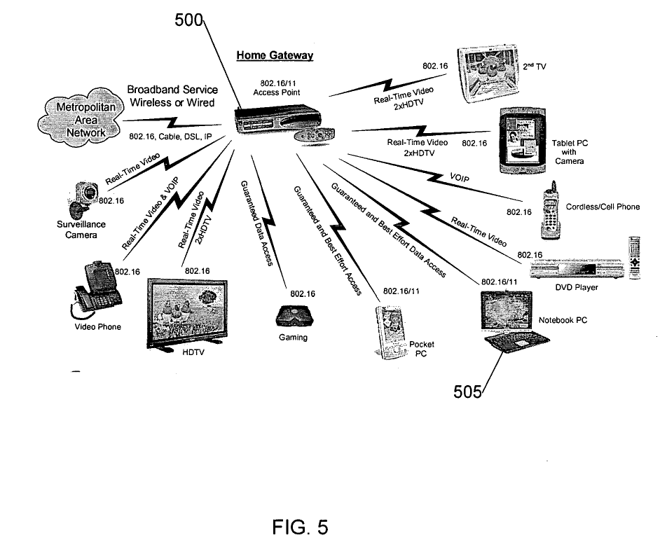

FIG. 5 is a diagram of a wireless network system running a multimedia distribution network for a home. In one embodiment such a network provides wireless distribution of video, voice, best effort data, and data with guaranteed information rates. In this example the set top box 500 functions as the base station. It is central and as such has the most efficient bandwidth and source of data. If the set top box 500 fails then one of the other items in this system can take over the base station functions. In this example the next in line to become the base station may be the notebook PC 505. Thus, the PC 505 is enabled with an ASIC which can switch between being an subscriber station to being a base station. Once the PC determines that the set top box 500 has failed it reconfigures itself to a base station so that it may take over. The owner of this network can override the self-configuration if desired.

In a second embodiment a wireless self-healing system could be used in a military convoy. This system has a high QoS to communicate both within the convoy and the outside world. Numerous convoy members may be fitted with the capability to communicate via the base station via a unmanned aerial vehicle (UAV) to facilitate convoy communications with entities outside the convoy. All but one of the convoy members is acting in subscriber station mode with only one acting in base station mode. If, during the course of its movement, the convoy splits or otherwise is too far spread for a single access point to serve the convoy, one of the other appropriately fitted convoy members may detect this disruption of communication and can reconfigure itself as a base station. This allows the network to self-heal itself and retain connectivity and strong QoS. In this situation the self-healing occurs for reasons other than a malfunctioning of the original base station. Similarly, the ability to be commanded to change modes allows the commander of the convoy to effect an override of the results of the self-healing if desired.

Various embodiments may also be implemented using a combination of both hardware and software.

The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for providing a self-healing and self-organizing wireless network, comprising:
establishing a base station configured to communicate with an outside network;
establishing one or more subscriber stations configured to communicate with the base station;
at least one of the subscriber stations monitoring for removal of the base station;
in the event removal of the base station, selecting a subscriber station to take over as a new base station for communications between the subscriber stations and outside network; and
switching the selected subscriber station to act as the new base station.

2. The method of claim 1, wherein the communications with the outside network are performed via a satellite communications link.

3. The method of claim 1, wherein the communications with the outside network are performed via a wireless link.

4. The method of claim 1, wherein the wireless link is provided by an unmanned aerial vehicle.

5. The method of claim 1, wherein the communications with the outside network are performed via a wired link.

6. The method of claim 1, wherein the subscriber station maintains a connection to the outside network.

7. A self-healing and self-organizing wireless network system, comprising:
a first communication device configured to operate as a base station for communication with an outside network;
a second communication device comprising a switchable communication device configured for selective operation in a subscriber station mode for communicating with the outside network via the base station or in a base station mode for communication with the outside network and with other subscriber stations;
the second communication device having a network control module configured to monitor for base station failure, and an a network control module configured to switch the second communication device into the base station mode to take over the functions of the original base station and operate as a new base station for communicating with the outside network in the event of base station failure.

8. The system as claimed in claim 7, comprising at least one additional communication device initially configured to operate as a subscriber station, the outside communications module of the second communication device further being configured to establish communications with the additional subscriber station when configured to operate as a new base station,

9. The system as claimed in claim 8, comprising a plurality of additional communication devices, at least some of the additional communication devices comprising switchable communication devices configured for selective operation in a subscriber station mode or a base station mode.

10. The system as claimed in claim 7, wherein the outside communications module is further configured to establish a dedicated connection to the outside network when the module is switched to base station mode, and to maintain the dedicated connection to the outside network.

11. The system of claim 7, wherein each communication device is an application specific integrated circuit (ASIC).

12. The system of claim 11, wherein one or more ASICs has the physical elements which are used in both subscriber stations and base stations.

13. The system of claim 7, wherein each communication device further comprises a media access control (MAC) functional entity configured to allocate available bandwidth on one or more physical channels.

14. A system of claim 8, wherein each switchable communication device has an initiation module configured to determine the next base station in the event of a base station failure by allowing the subscriber stations to negotiate with one another using predetermined variable criteria to ascertain which one will become the next base station.

15. A system for providing a self-healing and self-organizing wireless network comprising:
at least one communication device configured to be a base station;
at least one communication device configured to be a subscriber station;
a initiation module configured to
determine whether a communications device will be a base station or a subscriber station, and
establish a base station;
a outside connections module configured to
establish a dedicated connection to the outside network, and
maintain a dedicated connection to the outside network;
a confirmation of leadership module configured to
register a subscriber station with a base station, and
confirm that the subscriber station is still in contact with the base station; and
a connection failure module configured to
determine if the base station has failed, and notify the initiation module that the base station has failed.

16. A system of claim 15, wherein the initiation module determines the next base station by allowing the subscriber stations to negotiate with one another using. predetermined variable criteria to ascertain which one will become the next base station.

17. A system of claim 15, wherein the initiation module selects the next base station by a predetermined “next in line” plan, wherein a specific subscriber station has already been determined to be the next base station.

18. A system of claim 15, wherein once a base station fails the subscriber stations delay for a random period of time and then send out a signal announcing its presence as a new base station.

19. A system of claim 15, wherein once a base station fails human intervention is used to decide which subscriber station will become the new base station.
